(19) United States
(12) Patent Application Publication
(10) Pub. No.: US 2024/0144036 A1
(43) Pub. Date: May 2, 2024

(54) APPARATUS FOR EMISSIONS PREDICTIONS

(71) Applicant: Hammel Companies Inc., Pittsburgh, PA (US)

(72) Inventor: Joseph Charles Dohrn, Woodland Park, CO (US)

(73) Assignee: Hammel Companies Inc., Pittsburgh, PA (US)

(21) Appl. No.: 17/976,255

(22) Filed: Oct. 28, 2022

(51) Int. Cl. G06N 5/02; G06F 3/04847

(52) U.S. Cl. CPC G06N 5/022; G06F 3/04847

(57) ABSTRACT

In an aspect an apparatus for generating emissions predictions is presented. An apparatus includes at least a processor and a memory communicatively connected to the at least a processor. A memory contains instructions configuring at least a processor to receive transport data of a transport from at least a transport entity. At least a processor is configured to extract emission data from transport data. At least a processor is configured to classify emission data to a transparency level. At least a processor is configured to generate an emissions prediction as a function of emission data and a transparency level. At least a processor is configured to display, through a graphical user interface, an emissions prediction and a transparency level to a user.

### FIELD OF THE INVENTION

The present invention generally relates to the field of emissions predictions. In particular, the present invention is directed to an apparatus for emissions predictions.

### BACKGROUND

Modern supply chains often lack visibility of true emission data of various transports. Accordingly, modern apparatuses for emissions predictions can be improved.

### SUMMARY OF THE DISCLOSURE

In an aspect an apparatus for generating emissions predictions is presented. An apparatus includes at least a processor and a memory communicatively connected to the at least a processor. A memory contains instructions configuring at least a processor to receive transport data of a transport from at least a transport entity. At least a processor is configured to extract emission data from transport data. At least a processor is configured to classify emission data to a transparency level. At least a processor is configured to generate an emissions prediction as a function of emission data and a transparency level. At least a processor is configured to display, through a graphical user interface, an emissions prediction and a transparency level to a user.

In another aspect a method of generating emissions predictions is presented. A method includes receiving, via at least a processor, transport data of a transport from at least a transport entity. A method includes extracting, via at least a processor, emission data from transport data. A method includes classifying, via at least a processor, emission data to a transparency level. A method includes generating, via at least a processor, an emissions prediction of a transport as a function of emission data and a transparency level. A method includes displaying, through a graphical user interface, an emissions prediction and a transparency level to a user.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exemplary embodiment of a block diagram of an apparatus for generating emissions predictions;

FIG. 2 illustrates an exemplary embodiment of a graphical user interface;

FIG. 3 illustrates an exemplary embodiment of an immutable sequential listing;

FIG. 4 is an exemplary embodiment of a block diagram of a machine learning model;

FIG. 5 is a flowchart of an exemplary embodiment of a method of generating emissions predictions; and

FIG. 6 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses and methods for generating emissions predictions. In an embodiment, an apparatus may generate a graphical user interface displaying emissions predictions.

Aspects of the present disclosure can be used to classify transport data of transport entities to a transparency level. Aspects of the present disclosure can also be used to generate emissions predictions of one or more transports. Exemplary embodiments illustrating aspects of the present disclosure are described below in the context of several specific examples.

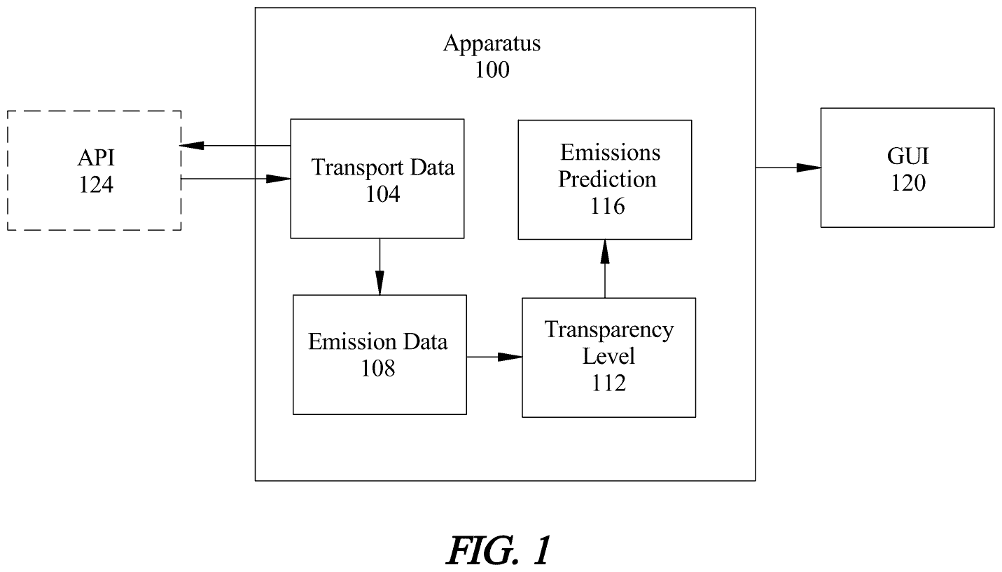

Referring now to FIG. 1, an exemplary embodiment of apparatus 100 for generating emissions predictions is illustrated. Apparatus 100 may include at least a processor and a memory communicatively connected to the at least a processor. As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. A memory may contain instructions configuring at least a processor to perform various tasks. In some embodiments, apparatus 100 may include a computing device such as any computing device as described in this disclosure, including without limitation a microcontroller, microprocessor, digital signal processor (DSP) and/or system on a chip (SoC) as described in this disclosure. Apparatus 100 may include, be included in, and/or communicate with a mobile device such as a mobile telephone or smartphone. Apparatus 100 may include a single computing device operating independently, or may include two or more computing device operating in concert, in parallel, sequentially or the like; two or more computing devices may be included together in a single computing device or in two or more computing devices. Apparatus 100 may interface or communicate with one or more additional devices as described below in further detail via a network interface device. Network interface device may be utilized for connecting apparatus 100 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Apparatus 100 may include but is not limited to, for example, a computing device or cluster of computing devices in a first location and a second computing device or cluster of computing devices in a second location. Apparatus 100 may include one or more computing devices dedicated to data storage, security, distribution of traffic for load balancing, and the like. Apparatus 100 may distribute one or more computing tasks as described below across a plurality of computing devices of computing device, which may operate in parallel, in series, redundantly, or in any other manner used for distribution of tasks or memory between computing devices. Apparatus 100 may be implemented using a “shared nothing” architecture in which data is cached at the worker, in an embodiment, this may enable scalability of system 100 and/or computing device.

With continued reference to FIG. 1, apparatus 100 may be designed and/or configured to perform any method, method step, or sequence of method steps in any embodiment described in this disclosure, in any order and with any degree of repetition. For instance, apparatus 100 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Apparatus 100 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, in some embodiments, apparatus 100 may be configured to receive transport data 104. “Transport data” as used throughout this disclosure is information pertaining to shipments. A “transport” as used in this discourse is a moving of one or more objects between two or more locations through a vehicle. In some embodiments, transports may include shipments. Transport data 104 may include, without limitation, origins, destinations, transport values, transport duration, transport routes, transport equipment, transport components, and the like. “Transport components” as used in this disclosure are objects involved in a shipment. Transport components may include, without limitation, construction materials, electronics, consumer goods, perishables, hazardous materials, non-hazardous materials, automobiles, vehicle parts, clothing, and the like. In some embodiments, transport data 104 may include transport component data. “Transport component data” as used in this disclosure is information pertaining to one or more transport components. Transport component data may include, without limitation, dimensions such as heights, widths, lengths, volumes, weights, estimated values, hazardous classifications, identifiers, and the like. “Transport routes” as used in this disclosure are paths taken during a shipment. Transport routes may include, without limitation, origins, destinations, stopping points, handover points, delivery times, streets, cities, states, longitudes, latitudes, and the like. “Transport equipment” as used in this discourse is any machinery used in a shipment. Transport equipment may include, but is not limited to, conveyor belts, forklifts, cars, trucks, ships, drones, airplanes, lighting equipment, warehouses, and the like. “Transport values” as used in this disclosure are metrics of worth associated with one or more transports and/or transport components. Transport values may be in a form of currency, such as dollars. In some embodiments, transport values may include one or more costs associated with completing a transport, such as, but not limited to, carrier costs, shipping costs, expedited fees, and the like. “Hazardous materials” as used in this disclosure are any objects having detrimental effects on the health of one or more individuals. Hazardous materials may include, but are not limited to, aerosol spray receptacles, airbags, alcohols, ammunition and gun powders, bleaches, camping equipment, car batteries, carbon dioxide canisters, car batteries, lithium batteries, dry ice, flammable items, fuels, hand sanitizers, inks, insecticides, lighters, mercury, wood treatment products, paint thinners and removers, and the like.

Still referring to FIG. 1, in some embodiments, apparatus 100 may be configured to classify transport data 104 to at least a transport parameter. A “transport parameter” as used in this disclosure is a variable of a transport. Transport parameters may include, but are not limited to, dates, times, fuel, vehicles, routes, and the like. Apparatus 100 may classify one or more elements of transport data 104 to one or more transport parameters. In some embodiments, apparatus 100 may utilize a transport parameter classifier to classify one or more elements of transport data 104 to one or more transport parameters. A transport parameter classifier may be trained with training data categorizing transport data to one or more transport parameters. Training data may be received through user input, external computing devices, and/or previous iterations of processing. A transport parameter classifier may receive transport data 104 and classify transport data 104 to one or more transport parameters. For instance, and without limitation, transport data 104 may include a destination, to which a transport parameter classifier may classify the destination to a “destination” or “route” category.

Still referring to FIG. 1, in some embodiments, apparatus 100 may be configured to receive transport data 104 from one or more transport entities. A “transport entity” as used in this disclosure is an individual and/or group of individuals involved in a transport. Transport entities may include, but are not limited to, carriers, shippers, warehouses, consumers, and the like. In some embodiments, apparatus 100 may receive transport data 104 from one or more transport entities through application programming interface (API) 124. An “application programming interface” as used in this disclosure is software allowing two or more computer programs to interact. API 124 may include, but is not limited to, open APIs, partner APIs, composite APIs, REST, RPC, SOAP, and/or other APIs. API 124 may communicate transport data 104 between one or more transport entities and apparatus 100 automatically, in timed intervals, in real-time, and the like, without limitation. In some embodiments, apparatus 100 and/or API 124 may communicate with a transport database. A “transport database” as used in this disclosure is a collection of transport data. A transport database may include data storage of one or more transport entities, such as, but not limited to, shippers, carriers, warehouses, cross-docks, and the like. Apparatus 100 and/or API 124 may communicate transport data 104 between a transport database.

Still referring to FIG. 1, in some embodiments, apparatus 100 may extract emission data 108 from transport data 104. “Emission data” as used in this disclosure is information pertaining to pollution of a transport. Pollution of a transport may include, without limitation, greenhouse gas emissions, such as carbon, carbon dioxide, methane, nitrous oxide, water vapor, fluorinated gases, and the like. Apparatus 100 may communicate emission data 108 directly from one or more transport entities. In other embodiments, apparatus 100 may extract emission data 108 from transport data 104 received from one or more transport entities. Extraction may include, without limitation, utilizing a language processing module. A language processing module may include any hardware and/or software module. Language processing module may be configured to extract, from the one or more documents, one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains” for example for use as a Markov chain or Hidden Markov Model.

Still referring to FIG. 1, a language processing module may operate to produce a language processing model. A language processing model may include a program automatically generated by computing device and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

Still referring to 1, a language processing module and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted words, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

Continuing to refer to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

Still referring to FIG. 1, language processing module may use a corpus of documents to generate associations between language elements in a language processing module, and diagnostic engine may then use such associations to analyze words extracted from one or more documents and determine that the one or more documents indicate significance of a category. In an embodiment, language module and/or apparatus 100 may perform this analysis using a selected set of significant documents, such as documents identified by one or more experts as representing good information; experts may identify or enter such documents via graphical user interface, or may communicate identities of significant documents according to any other suitable method of electronic communication, or by providing such identity to other persons who may enter such identifications into apparatus 100. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR as provided by Ithaka Harbors, Inc. of New York.

Still referring to FIG. 1, in some embodiments, emission data 108 may be received through data communicated through API 124. In some embodiments, API 124 may communicate transport data 104, emission data 108, and/or other data between one or more transport entities and apparatus 100. Apparatus 100 may sort, categorize, and/or classify data received from API 124, using any process described throughout this disclosure, without limitation. Apparatus 100 may sort data from API 124 by transport entity name, date received, last modified, transport identifiers, emission categories, transport data categories, and the like. Apparatus 100 may categorize and/or classify data received from API 124 into one or more groupings, such as, but not limited to, fuel usage, fuel type, transport duration, destination, origin, vehicle type, transport component type, driver metrics, and the like.

Still referring to FIG. 1, in some embodiments, emission data 108 may include, but is not limited to, type of fuel used, amount of fuel, transport routes, vehicle type, vehicle operator efficiency, transport component type, transport component packaging type, transport equipment type, and the like. In some embodiments, apparatus 100 may classify emission data 108 to transparency level 112. A “transparency level” as used in this disclosure is a metric of visibility of data shared from a transport entity. Transparency level 112 may include, but is not limited to, qualitative descriptions, such as basic, good, gold, and the like. A “basic” transparency level may include transport data 104 and/or emissions data 108 relating to destinations, origins, and/or vehicle type. A “good” transparency level 112 may include transport data 104 and/or emissions data 108 including data of a basic level and additional data relating to fuel usage, vehicle types, transport component dimensions, and the like. A “gold” transparency level may include data of a basic and/or good level and additional data such as, without limitation, vehicle operations metrics, transport component packaging type, warehousing metrics, transport route metrics, driver efficiency, and the like. In some embodiments, transparency level 112 may include a quantitative description, such as, but not limited to, percentages, one or more values, ranges of values, ratings out of 5, ratings out of 10, ratings out of 100, and the like. As a non-limiting example, a basic transparency level 112 may include transport data showing a transport is travelling from Wyoming to Ohio in an 18 wheeler. A good transparency level 112 may show the same transport is taking a specific transport route, using 400 gallons of fuel, and is transporting 10 tons of cement. A gold transparency level 112 may show additional transport data 104 of the same transport, such as hard stop data, idling data, exact vehicle model, exact transport component identifications, transport component packing data, warehouse power consumption, and the like. Apparatus 100 may utilize a classifier to classify transport data 104 and/or emissions data 108 to transparency level 112. A “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Computing device 104 and/or another device may generate a classifier using a classification algorithm, defined as a processes whereby a computing device 104 derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 1, computing device 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device 104 may then calculate a likelihood table by calculating probabilities of different data entries and classification labels. Computing device 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, computing device 104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

Still referring to FIG. 1, a classifier may be trained with training data correlating emission data 108 and/or transport data 104 to one or more transparency levels 112. Training data may be received through user input, external computing devices, and/or previous iterations of processing. In some embodiments, a classifier may be configured to receive transport data 104 and/or emission data 108 and output one or more transparency levels 112, such as, but not limited to, basic, good, gold, and the like. In some embodiments, apparatus 100 may utilize an emission data classifier to classify emission data 108 to one or more emission categories. An “emission category” as used in this disclosure is a grouping of information related to one or more greenhouse gases. Emission categories may include, but are not limited to, transport size, fuel, driver metrics, transport route, and the like. An “emission data classifier” as used in this disclosure is a machine learning process that categorizes emission data to one or more emission categories. An emission data classifier may be trained with training data correlating emission data 108 to one or more emission categories. Training data may be received through user input, external computing devices, and/or previous iterations of processing, without limitation. An emission data classifier may be configured to receive emissions data 108 and output one or more emission categories. For instance, and without limitation, an emission data classifier may receive emission data 108 including a total distance of a transport. An emission data classifier may classify emission data 108 to a transport route emission category.

Still referring to FIG. 1, in some embodiments, apparatus 100 may generate emissions prediction 116. An “emissions prediction” as used in this disclosure is an estimated amount of greenhouse gas. Emissions prediction 116 may include, without limitation, amounts of carbon, frequency of carbon emissions, average carbon emissions, difference in carbon emissions, and the like. Apparatus 100 may generate emissions prediction 116 for a single transport, multiple transports, and/or a timeline of transports. In some embodiments, apparatus 100 may utilize an emissions prediction machine learning model. An “emissions prediction machine learning model” as used in this disclosure is a machine learning process that inputs transport data and/or emission data and outputs one or more emissions predictions. An emissions prediction machine learning may be trained with training data correlating transport data and/or emission data to one or more emissions predictions. Training data may be received through user input, external computing devices, and/or previous iterations of processing, without limitation. An emissions prediction machine learning model may receive transport data 104 and/or emission data 108 and output one or more emissions predictions 116. For instance, and without limitation, transport data 104 and/or emission data 108 may show a transport of 40 lbs of bananas from Boston to New York on an overnight trip. An emissions prediction machine learning model may generate emissions prediction 116 of 10 metric tons of carbon.

Still referring to FIG. 1, in some embodiments, apparatus 100 may be configured to assign one or more emissions predictions 116 to one or more transport entities of a transport. For instance and without limitation, a first transport entity may be assigned an emissions prediction 116 of 12 metric tons of carbon, a second transport entity may be assigned an emissions prediction 116 of 4 metric tons of carbon, and a third transport entity may be assigned an emissions prediction 116 of 20 metric tons of carbon. Apparatus 100 may rank one or more transport entities as a function of emissions prediction 116. Ranking may include ordering a sequence and/or listing of a plurality of transport entities according to one or more criteria. In some embodiments, a criteria of a ranking of a plurality of transport entities may include a largest emissions prediction 116, smallest emissions prediction 116, and the like, without limitation. For instance, continuing the above example, the first transport entity may be assigned a rank of “2”, the second transport entity may be assigned a rank of “1”, and the third transport entity may be assigned a rank of “3”.

Still referring to FIG. 1, in some embodiments, apparatus 100 may be configured to calculate a confidence metric of emissions prediction 116. A “confidence metric” as used in this disclosure is a value or values pertaining to a certainty of an element. A confidence metric may include, without limitation, a value out of 10, out of 100, out of 5 stars, and the like. Apparatus 100 may calculate a confidence metric of emissions prediction 116 based on transparency level 112. For instance, and without limitation, transparency level 112 may show a basic transparency level of a transport entity. Apparatus 100 may determine that, due to a low-ranking transparency level 112, emissions prediction 116 may be inaccurate and calculate a confidence metric of 65% confident, as a non-limiting example. Apparatus 100 may be configured to correlate transparency level 112 with emissions prediction 116. Correlation may include linking data of transparency level 112 to data of emissions prediction 116, emission data 108, and/or transport data 104. Correlation may include determining influences of transparency levels 112 on emissions prediction 116. For instance, and without limitation, correlation may show that low transparency level 112 rankings may cause inaccurate emissions prediction 116. Furthering this example, higher transparency level 112 rankings may result in more accurate emissions predictions 116 having a higher confidence metric. In some embodiments, a higher-ranking transparency level 112 may tend to increase quantities of emission of emissions prediction 116. For instance, and without limitation, a carrier may initially have low-ranking transparency level 112 which and low emissions prediction 116. The carrier may increase in transparency level 112 ranking, which may include more detailed transport data 104 and/or emission data 108 being communicated to apparatus 100. An increase in available data of transport data 104 and/or emissions data 108 may increase levels of emissions of emissions prediction 116 of a carrier, which may be due, in part, to the increase data available to calculate emissions prediction 116. Apparatus 100 may be configured to display a correlation of transparency level 112 and emissions prediction 116 of one or more transport entities through GUI 120.

Still referring to FIG. 1, apparatus 100 may be configured to generate an emissions optimization model. An emissions optimization model may include an optimization model. An optimization model may include an optimization criterion. An “optimization criterion” as used in this disclosure is a value that is sought to be maximized or minimized in a process. An optimization criterion may include any description of a desired value or range of values for one or more attributes of an oral aid; desired value or range of values may include a maximal or minimal value, a range between maximal or minimal values, or an instruction to maximize or minimize an attribute. As a non-limiting example, an optimization criterion may specify that a fuel usage of transport should be minimized, for instance by minimizing emissions of a transport; an optimization criterion may limit a transport time, for instance specifying that a transport must be completed before a certain date or time, or within a certain period of time. An optimization criterion may alternatively request that a transport time be greater than a certain value. An optimization criterion may specify one or more tolerances for precision in a route of a transport. An optimization criterion may specify one or more desired cost attributes for a transport. In an embodiment, at least an optimization criterion may assign weights to different attributes or values associated with attributes; weights, as used herein, may be multipliers or other scalar numbers reflecting a relative importance of a particular attribute or value. One or more weights may be expressions of value to a user for a particular outcome, attribute value, or other facet of a transport request; value may be expressed, as a non-limiting example, in remunerative form, such as a quantity of a medium of exchange, a monetary unit, or the like. As a non-limiting example, minimization of transport cost may be multiplied by a first weight, while tolerance above a certain value may be multiplied by a second weight. Optimization criteria may be combined in weighted or unweighted combinations into a function reflecting an overall outcome desired by a user; function may be a cost function to be minimized and/or maximized. Function may be defined by reference to transport constraints and/or weighted aggregation thereof as provided by a plurality of remote computing devices; for instance, a cost function combining optimization criteria may seek to minimize or maximize a function of transport constraints. As a non-limiting example, a cost function combining optimization criteria may seek to minimize emissions of a transport. As another non-limiting example, a cost function combining optimization criteria may seek to maximize a quantity of transport components delivered.

Still referring to FIG. 1, generation of an emissions optimization model may include generation of a function to score and weight factors to achieve an emissions score for each feasible pairing. In some embodiments, pairings may be scored in a matrix for optimization, where columns represent transports and rows represent emissions and/or emissions predictions potentially paired therewith; each cell of such a matrix may represent a score of a pairing of the corresponding transport to the corresponding emission. In some embodiments, assigning a predicted process that optimizes the objective function includes performing a greedy algorithm process. A “greedy algorithm” is defined as an algorithm that selects locally optimal choices, which may or may not generate a globally optimal solution. For instance, an emissions optimization model may select pairings so that scores associated therewith are the best score for each transport and/or for each emissions prediction. In such an example, optimization may determine the combination of transports such that each emissions prediction pairing includes the highest score possible.

Still referring to FIG. 1, an emissions optimization model may be formulated as a linear objective function. An emissions optimization model may solve an objective function using a linear program such as without limitation a mixed-integer program. A “linear program,” as used in this disclosure, is a program that optimizes a linear objective function, given at least a constraint. For instance, and without limitation, objective function may seek to maximize a total score Σ_{r∈R}Σ_{s∈S}cᵣₛxᵣₛ, where R is a set of all transports r, S is a set of all emissions predictions s, cᵣₛ is a score of a pairing of a given transport with a given emissions prediction, and xᵣₛ is 1 if a transport r is paired with an emissions prediction s, and 0 otherwise. Continuing the example, constraints may specify that each transport is assigned to only one emissions prediction, and each emissions prediction is assigned only one transport. Transports may include transports as described above. Sets of transports may be optimized for a maximum score combination of all generated transports. In various embodiments, an emissions optimization model may determine a combination of transports that maximizes a total score subject to a constraint that all transports are paired to exactly one emissions prediction. Not all transports may receive an emissions prediction pairing since each transport may only receive one emissions prediction. A mathematical solver may be implemented to solve for the set of feasible pairings that maximizes the sum of scores across all pairings; mathematical solver may be implemented on apparatus 100 and/or another device, and/or may be implemented on third-party solver.

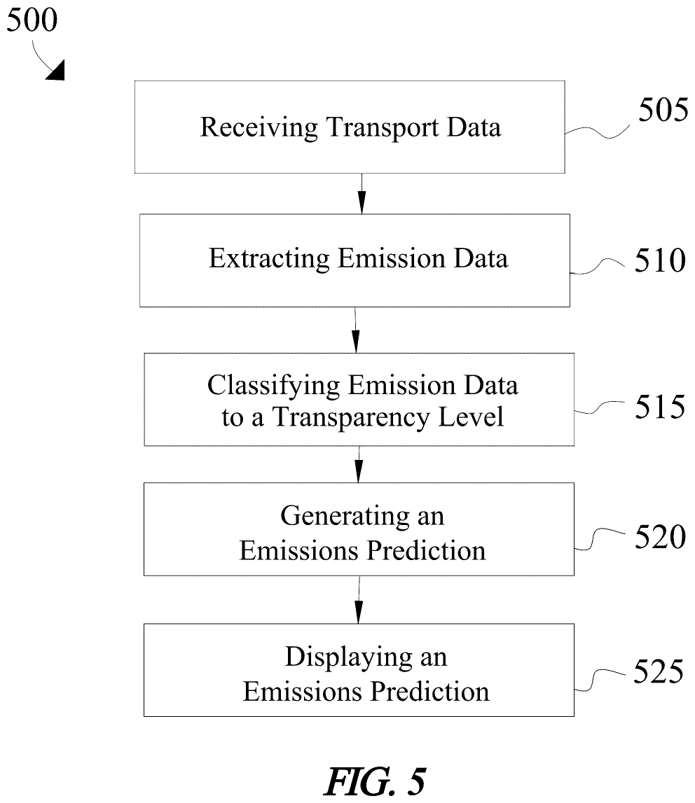

With continued reference to FIG. 1, an emissions optimization model may include minimizing a loss function, where a “loss function” is an expression an output of which an optimization model minimizes to generate an optimal result. As a non-limiting example, an emissions optimization model may assign variables relating to a set of parameters, which may correspond to score transports as described above, calculate an output of mathematical expression using the variables, and select a pairing that produces an output having the lowest size, according to a given definition of “size,” of the set of outputs representing each of a plurality of candidate emissions predictions; size may, for instance, included absolute value, numerical size, or the like. Selection of different loss functions may result in identification of different potential pairings as generating minimal outputs. Objectives represented in an objective function and/or loss function may include minimization of cost. Objectives may include minimization of transport time. Objectives may include minimization of carriers and/or resources used. Objectives may include minimization of emissions produced. Apparatus 100 may use a machine-learning model to generate optimization criteria and/or objective functions. A machine-learning model may be as described with reference to FIG. 5.

Still referring to FIG. 1, in some embodiments, apparatus 100 may utilize and/or generate an emission optimization model to minimize levels of a pollutant of emissions prediction 116. “Levels of a pollutant” as used in this disclosure are quantities of greenhouse gases. Levels of a pollutant may include, but are not limited to, quantities of carbon, quantities of smog, quantities of methane, and/or other quantities of pollutants. Levels of a pollutant may be measured in, without limitation, metric tons, cubic feet, kilograms, and the like. Apparatus 100 may determine one or more parameters of emission data 108 and/or transport data 104 that may influence emissions prediction 116. For instance, and without limitation, emission data 108 may show a carrier takes inefficient routes. Apparatus 100 may determine another carrier takes more efficient routes which may reduce emissions prediction 116 and/or levels of a pollutant. Apparatus 100 may compare a plurality of transport entities, such as without limitation carriers, to a plurality of emissions predictions 116 to minimize levels of a pollutant of a transport. In some embodiments, apparatus 100 may utilize any machine learning model as described throughout this disclosure, without limitation, to minimize levels of a pollutant.

Still referring to FIG. 1, in some embodiments, apparatus 100 may be configured to calculate a predicted emissions timeline. A “predicted emissions timeline” as used in this disclosure is a temporal projection of levels of a pollutant. A predicted emissions timeline may include, without limitation, times, dates, days, weeks, months, years, decades, and the like. As a non-limiting example, predicted emissions timeline may include projected levels of a pollutant for each month over the course of a year. In some embodiments, apparatus 100 may generate a predicted emissions timeline as a function of transport data 104, emission data 108, and/or emissions prediction 116. Apparatus 100 may display a predicted emissions timeline through GUI 120. For instance, and without limitation, apparatus 100 may determine a predicted emissions timeline over a course of a year, showing a decreased trend of 10% levels of a pollutant of emissions prediction 116. In some embodiments, apparatus 100 may utilize any machine learning model as used in this disclosure, without limitation, to generate a predicted emissions timeline.

Still referring to FIG. 1, in some embodiments, apparatus 100 may generate graphical user interface (GUI) 120. A “graphical user interface” as used in this disclosure is an interface including a set of one or more pictorial and/or graphical icons corresponding to one or more computer actions. GUI 120 may be configured to receive user input, as described above. GUI 120 may include one or more event handlers. An “event handler” as used in this disclosure is a callback routine that operates asynchronously once an event takes place. Event handlers may include, without limitation, one or more programs to perform one or more actions based on user input, such as generating pop-up windows, submitting forms, changing background colors of a webpage, and the like. Event handlers may be programmed for specific user input, such as, but not limited to, mouse clicks, mouse hovering, touchscreen input, keystrokes, and the like. For instance and without limitation, an event handler may be programmed to generate a pop-up window if a user double clicks on a specific icon. User input may include, a manipulation of computer icons, such as, but not limited to, clicking, selecting, dragging and dropping, scrolling, and the like. In some embodiments, user input may include an entry of characters and/or symbols in a user input field. A “user input field” as used in this disclosure is a portion of a graphical user interface configured to receive data from an individual. A user input field may include, but is not limited to, text boxes, search fields, filtering fields, and the like. In some embodiments, user input may include touch input. Touch input may include, but is not limited to, single taps, double taps, triple taps, long presses, swiping gestures, and the like. One of ordinary skill in the art will appreciate the various ways a user may interact with graphical user interface 120.

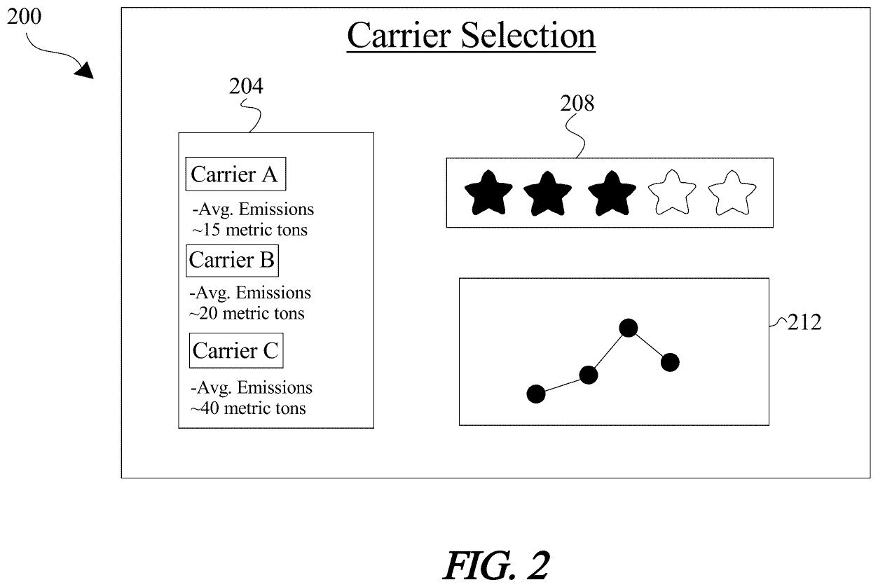

Referring now to FIG. 2, an exemplary embodiment of GUI 200 is presented. GUI 200 may include GUI 120 as described above with reference to FIG. 1. In some embodiments, GUI 200 may include transport entity listing 204. A “transport entity listing” as used in this disclosure is an arrangement of two or more individuals and/or groups. Transport entity listing 204 may be arranged by levels of emissions predictions. For instance and without limitation, a first carrier may be displayed on top of transport entity listing 204, where the first carrier has the least amount of average emissions. A second carrier may be displayed underneath a first carrier, where the second carrier has a higher average emission level than the first carrier. A third carrier may be displayed underneath both a first carrier and a second carrier, where the third carrier has a highest average emission amount of all three carriers. In other embodiments, transport entity listing 204 may be arranged by, but not limited to, cost, delivery times, frequently used, and the like. For instance and without limitation, a user may frequently use “Carrier B”, which may be displayed at a top of transport entity listing 204 due to a frequent selection of Carrier B.

Still referring to FIG. 2, in some embodiments, GUI 200 may display transparency level 208. Transparency level 208 may include transparency level 112 as described above with reference to FIG. 1. In some embodiments, transparency level 208 may be in a form of a percentage, scale out of 10, scale out of 100, scale out of 5 stars, and the like, without limitation. An increased value of transparency level 208 may correspond to a higher transparency level of a transport entity. In some embodiments, transparency level 208 may also display a confidence metric. A confidence metric may include, without limitation, a value out of 5, out of 10, out of 100, a percentage, and the like. For instance and without limitation, transparency level 208 may display a confidence level of 78% confident of emissions prediction 212 based on transparency level 208. Emissions prediction 212 may include emissions prediction 116 as described above with reference to FIG. 1. Emissions prediction 212 may show a prediction of emissions for an upcoming transport, a previous transport, average transports, a timeline of transports, and the like, without limitation.

Still referring to FIG. 2, in some embodiments GUI 200 may display one or more selectable transport parameters. A “selectable transport parameter” as used in this discourse is a graphic element corresponding to a metric of a shipment. Selectable transport parameters may include, but are not limited to, dates, times, packaging material, routes, and the like. A user may interact with one or more selectable transport parameters through, but not limited to, touch input, mouse input, and the like. GUI 200 may display changes in emissions prediction 212 based on adjustments to one or more selectable transport parameters. In some embodiments, GUI 200 may adjust a transport parameter of a transport as a function of user input and calculate a second emissions prediction 212 as a function of the adjusted transport parameter, which may be displayed through GUI 200. For instance and without limitation, a first emissions prediction 212 may show an estimated emissions level of 30 metric tons of carbon. A user may adjust one or more transport parameters through one or more selectable transport parameters, to which GUI 200 may display a second emissions prediction 212. GUI 200 may display a first emissions prediction 212 along a second emissions prediction 212. In some embodiments, emissions prediction 212 may display two or more emissions prediction timelines, such as emissions prediction timelines as described above with reference to FIG. 1. In some embodiments, a user may click on or otherwise interact with transport entity listing 204, transparent level 208, and/or emissions prediction 212. Emissions prediction 212, upon interaction with user input, may display one or more windows, icons, and the like. Emissions prediction 212 may display a correlation between a level of emissions and transparency level 208. For instance and without limitation, emissions prediction 212 may display Carrier A shipped 100 video game consoles from Texas to Boston and has an emissions prediction 212 of about 65 metric tons of carbon. A user may interact with this data point of emissions prediction 212, which may display a drop-down menu or other graphical element, without limitation, showing transparency level 208 associated with that specific shipment.

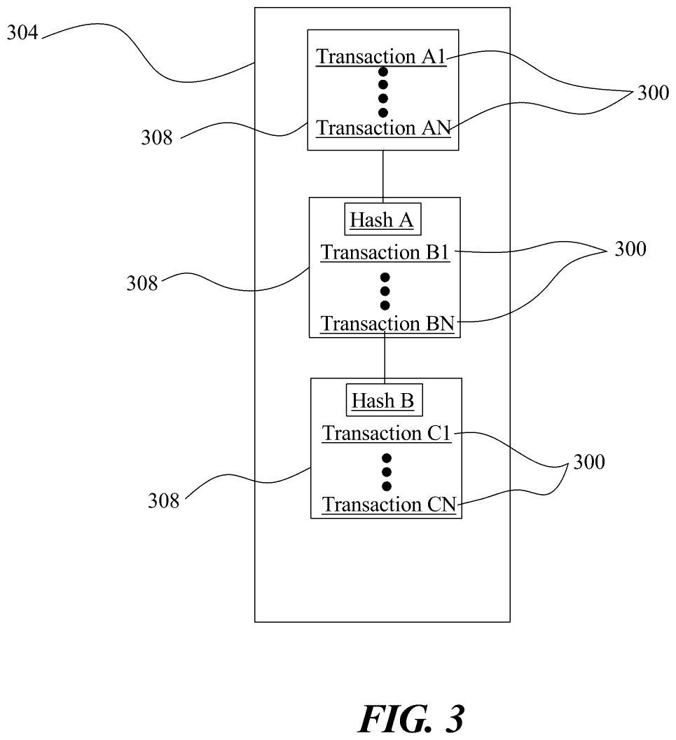

Referring now to FIG. 3, an exemplary embodiment of an immutable sequential listing 300 is illustrated. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered. Data elements are listing in immutable sequential listing 300; data elements may include any form of data, including textual data, image data, encrypted data, cryptographically hashed data, and the like. Data elements may include, without limitation, one or more at least a digitally signed assertions. In one embodiment, a digitally signed assertion 304 is a collection of textual data signed using a secure proof as described in further detail below; secure proof may include, without limitation, a digital signature as described above. Collection of textual data may contain any textual data, including without limitation American Standard Code for Information Interchange (ASCII), Unicode, or similar computer-encoded textual data, any alphanumeric data, punctuation, diacritical mark, or any character or other marking used in any writing system to convey information, in any form, including any plaintext or cyphertext data; in an embodiment, collection of textual data may be encrypted, or may be a hash of other data, such as a root or node of a Merkle tree or hash tree, or a hash of any other information desired to be recorded in some fashion using a digitally signed assertion 304. In an embodiment, collection of textual data states that the owner of a certain transferable item represented in a digitally signed assertion 304 register is transferring that item to the owner of an address. A digitally signed assertion 304 may be signed by a digital signature created using the private key associated with the owner's public key, as described above.

Still referring to FIG. 3, a digitally signed assertion 304 may describe a transfer of virtual currency, such as crypto-currency as described below. The virtual currency may be a digital currency. Item of value may be a transfer of trust, for instance represented by a statement vouching for the identity or trustworthiness of the first entity. Item of value may be an interest in a fungible negotiable financial instrument representing ownership in a public or private corporation, a creditor relationship with a governmental body or a corporation, rights to ownership represented by an option, derivative financial instrument, commodity, debt-backed security such as a bond or debenture or other security as described in further detail below. A resource may be a physical machine e.g. a ride share vehicle or any other asset. A digitally signed assertion 304 may describe the transfer of a physical good; for instance, a digitally signed assertion 304 may describe the sale of a product. In some embodiments, a transfer nominally of one item may be used to represent a transfer of another item; for instance, a transfer of virtual currency may be interpreted as representing a transfer of an access right; conversely, where the item nominally transferred is something other than virtual currency, the transfer itself may still be treated as a transfer of virtual currency, having value that depends on many potential factors including the value of the item nominally transferred and the monetary value attendant to having the output of the transfer moved into a particular user's control. The item of value may be associated with a digitally signed assertion 304 by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland, the Thunder protocol developed by Thunder Consensus, or any other protocol.

Still referring to FIG. 3, in one embodiment, an address is a textual datum identifying the recipient of virtual currency or another item of value in a digitally signed assertion 304. In some embodiments, address is linked to a public key, the corresponding private key of which is owned by the recipient of a digitally signed assertion 304. For instance, address may be the public key. Address may be a representation, such as a hash, of the public key. Address may be linked to the public key in memory of a computing device, for instance via a “wallet shortener” protocol. Where address is linked to a public key, a transferee in a digitally signed assertion 304 may record a subsequent a digitally signed assertion 304 transferring some or all of the value transferred in the first a digitally signed assertion 304 to a new address in the same manner. A digitally signed assertion 304 may contain textual information that is not a transfer of some item of value in addition to, or as an alternative to, such a transfer. For instance, as described in further detail below, a digitally signed assertion 304 may indicate a confidence level associated with a distributed storage node as described in further detail below.

In an embodiment, and still referring to FIG. 3 immutable sequential listing 300 records a series of at least a posted content in a way that preserves the order in which the at least a posted content took place. Temporally sequential listing may be accessible at any of various security settings; for instance, and without limitation, temporally sequential listing may be readable and modifiable publicly, may be publicly readable but writable only by entities and/or devices having access privileges established by password protection, confidence level, or any device authentication procedure or facilities described herein, or may be readable and/or writable only by entities and/or devices having such access privileges. Access privileges may exist in more than one level, including, without limitation, a first access level or community of permitted entities and/or devices having ability to read, and a second access level or community of permitted entities and/or devices having ability to write; first and second community may be overlapping or non-overlapping. In an embodiment, posted content and/or immutable sequential listing 300 may be stored as one or more zero knowledge sets (ZKS), Private Information Retrieval (PIR) structure, or any other structure that allows checking of membership in a set by querying with specific properties. Such database may incorporate protective measures to ensure that malicious actors may not query the database repeatedly in an effort to narrow the members of a set to reveal uniquely identifying information of a given posted content.

Still referring to FIG. 3, immutable sequential listing 300 may preserve the order in which the at least a posted content took place by listing them in chronological order; alternatively or additionally, immutable sequential listing 300 may organize digitally signed assertions 304 into sub-listings 308 such as “blocks” in a blockchain, which may be themselves collected in a temporally sequential order; digitally signed assertions 304 within a sub-listing 308 may or may not be temporally sequential. The ledger may preserve the order in which at least a posted content took place by listing them in sub-listings 308 and placing the sub-listings 308 in chronological order. The immutable sequential listing 300 may be a distributed, consensus-based ledger, such as those operated according to the protocols promulgated by Ripple Labs, Inc., of San Francisco, Calif., or the Stellar Development Foundation, of San Francisco, Calif, or of Thunder Consensus. In some embodiments, the ledger is a secured ledger; in one embodiment, a secured ledger is a ledger having safeguards against alteration by unauthorized parties. The ledger may be maintained by a proprietor, such as a system administrator on a server, that controls access to the ledger; for instance, the user account controls may allow contributors to the ledger to add at least a posted content to the ledger, but may not allow any users to alter at least a posted content that have been added to the ledger. In some embodiments, ledger is cryptographically secured; in one embodiment, a ledger is cryptographically secured where each link in the chain contains encrypted or hashed information that makes it practically infeasible to alter the ledger without betraying that alteration has taken place, for instance by requiring that an administrator or other party sign new additions to the chain with a digital signature. Immutable sequential listing 300 may be incorporated in, stored in, or incorporate, any suitable data structure, including without limitation any database, datastore, file structure, distributed hash table, directed acyclic graph or the like. In some embodiments, the timestamp of an entry is cryptographically secured and validated via trusted time, either directly on the chain or indirectly by utilizing a separate chain. In one embodiment the validity of timestamp is provided using a time stamping authority as described in the RFC 3161 standard for trusted timestamps, or in the ANSI ASC x9.95 standard. In another embodiment, the trusted time ordering is provided by a group of entities collectively acting as the time stamping authority with a requirement that a threshold number of the group of authorities sign the timestamp.

In some embodiments, and with continued reference to FIG. 3, immutable sequential listing 300, once formed, may be inalterable by any party, no matter what access rights that party possesses. For instance, immutable sequential listing 300 may include a hash chain, in which data is added during a successive hashing process to ensure non-repudiation. Immutable sequential listing 300 may include a block chain. In one embodiment, a block chain is immutable sequential listing 300 that records one or more new at least a posted content in a data item known as a sub-listing 308 or “block.” An example of a block chain is the BITCOIN block chain used to record BITCOIN transactions and values. Sub-listings 308 may be created in a way that places the sub-listings 308 in chronological order and link each sub-listing 308 to a previous sub-listing 308 in the chronological order so that any computing device may traverse the sub-listings 308 in reverse chronological order to verify any at least a posted content listed in the block chain. Each new sub-listing 308 may be required to contain a cryptographic hash describing the previous sub-listing 308. In some embodiments, the block chain contains a single first sub-listing 308 sometimes known as a “genesis block.”

Still referring to FIG. 3, the creation of a new sub-listing 308 may be computationally expensive; for instance, the creation of a new sub-listing 308 may be designed by a “proof of work” protocol accepted by all participants in forming the immutable sequential listing 300 to take a powerful set of computing devices a certain period of time to produce. Where one sub-listing 308 takes less time for a given set of computing devices to produce the sub-listing 308 protocol may adjust the algorithm to produce the next sub-listing 308 so that it will require more steps; where one sub-listing 308 takes more time for a given set of computing devices to produce the sub-listing 308 protocol may adjust the algorithm to produce the next sub-listing 308 so that it will require fewer steps. As an example, protocol may require a new sub-listing 308 to contain a cryptographic hash describing its contents; the cryptographic hash may be required to satisfy a mathematical condition, achieved by having the sub-listing 308 contain a number, called a nonce, whose value is determined after the fact by the discovery of the hash that satisfies the mathematical condition. Continuing the example, the protocol may be able to adjust the mathematical condition so that the discovery of the hash describing a sub-listing 308 and satisfying the mathematical condition requires more or less steps, depending on the outcome of the previous hashing attempt. Mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, production of a new sub-listing 308 according to the protocol is known as “mining.” The creation of a new sub-listing 308 may be designed by a “proof of stake” protocol as will be apparent to those skilled in the art upon reviewing the entirety of this disclosure.

Continuing to refer to FIG. 3, in some embodiments, protocol also creates an incentive to mine new sub-listings 308. The incentive may be financial; for instance, successfully mining a new sub-listing 308 may result in the person or entity that mines the sub-listing 308 receiving a predetermined amount of currency. The currency may be fiat currency. Currency may be cryptocurrency as defined below. In other embodiments, incentive may be redeemed for particular products or services; the incentive may be a gift certificate with a particular business, for instance. In some embodiments, incentive is sufficiently attractive to cause participants to compete for the incentive by trying to race each other to the creation of sub-listings 308 Each sub-listing 308 created in immutable sequential listing 300 may contain a record or at least a posted content describing one or more addresses that receive an incentive, such as virtual currency, as the result of successfully mining the sub-listing 308.

With continued reference to FIG. 3, where two entities simultaneously create new sub-listings 308, immutable sequential listing 300 may develop a fork; protocol may determine which of the two alternate branches in the fork is the valid new portion of the immutable sequential listing 300 by evaluating, after a certain amount of time has passed, which branch is longer. “Length” may be measured according to the number of sub-listings 308 in the branch. Length may be measured according to the total computational cost of producing the branch. Protocol may treat only at least a posted content contained the valid branch as valid at least a posted content. When a branch is found invalid according to this protocol, at least a posted content registered in that branch may be recreated in a new sub-listing 308 in the valid branch; the protocol may reject “double spending” at least a posted content that transfer the same virtual currency that another at least a posted content in the valid branch has already transferred. As a result, in some embodiments the creation of fraudulent at least a posted content requires the creation of a longer immutable sequential listing 300 branch by the entity attempting the fraudulent at least a posted content than the branch being produced by the rest of the participants; as long as the entity creating the fraudulent at least a posted content is likely the only one with the incentive to create the branch containing the fraudulent at least a posted content, the computational cost of the creation of that branch may be practically infeasible, guaranteeing the validity of all at least a posted content in the immutable sequential listing 300.

Still referring to FIG. 3, additional data linked to at least a posted content may be incorporated in sub-listings 308 in the immutable sequential listing 300; for instance, data may be incorporated in one or more fields recognized by block chain protocols that permit a person or computer forming a at least a posted content to insert additional data in the immutable sequential listing 300. In some embodiments, additional data is incorporated in an unspendable at least a posted content field. For instance, the data may be incorporated in an OP RETURN within the BITCOIN block chain. In other embodiments, additional data is incorporated in one signature of a multi-signature at least a posted content. In an embodiment, a multi-signature at least a posted content is at least a posted content to two or more addresses. In some embodiments, the two or more addresses are hashed together to form a single address, which is signed in the digital signature of the at least a posted content. In other embodiments, the two or more addresses are concatenated. In some embodiments, two or more addresses may be combined by a more complicated process, such as the creation of a Merkle tree or the like. In some embodiments, one or more addresses incorporated in the multi-signature at least a posted content are typical crypto-currency addresses, such as addresses linked to public keys as described above, while one or more additional addresses in the multi-signature at least a posted content contain additional data related to the at least a posted content; for instance, the additional data may indicate the purpose of the at least a posted content, aside from an exchange of virtual currency, such as the item for which the virtual currency was exchanged. In some embodiments, additional information may include network statistics for a given node of network, such as a distributed storage node, e.g. the latencies to nearest neighbors in a network graph, the identities or identifying information of neighboring nodes in the network graph, the trust level and/or mechanisms of trust (e.g. certificates of physical encryption keys, certificates of software encryption keys, (in non-limiting example certificates of software encryption may indicate the firmware version, manufacturer, hardware version and the like), certificates from a trusted third party, certificates from a decentralized anonymous authentication procedure, and other information quantifying the trusted status of the distributed storage node) of neighboring nodes in the network graph, IP addresses, GPS coordinates, and other information informing location of the node and/or neighboring nodes, geographically and/or within the network graph. In some embodiments, additional information may include history and/or statistics of neighboring nodes with which the node has interacted. In some embodiments, this additional information may be encoded directly, via a hash, hash tree or other encoding.

With continued reference to FIG. 3, in some embodiments, virtual currency is traded as a crypto-currency. In one embodiment, a crypto-currency is a digital, currency such as Bitcoins, Peercoins, Namecoins, and Litecoins. Crypto-currency may be a clone of another crypto-currency. The crypto-currency may be an “alt-coin.” Crypto-currency may be decentralized, with no particular entity controlling it; the integrity of the crypto-currency may be maintained by adherence by its participants to established protocols for exchange and for production of new currency, which may be enforced by software implementing the crypto-currency. Crypto-currency may be centralized, with its protocols enforced or hosted by a particular entity. For instance, crypto-currency may be maintained in a centralized ledger, as in the case of the XRP currency of Ripple Labs, Inc., of San Francisco, Calif. In lieu of a centrally controlling authority, such as a national bank, to manage currency values, the number of units of a particular crypto-currency may be limited; the rate at which units of crypto-currency enter the market may be managed by a mutually agreed-upon process, such as creating new units of currency when mathematical puzzles are solved, the degree of difficulty of the puzzles being adjustable to control the rate at which new units enter the market. Mathematical puzzles may be the same as the algorithms used to make productions of sub-listings 308 in a block chain computationally challenging; the incentive for producing sub-listings 308 may include the grant of new crypto-currency to the miners. Quantities of crypto-currency may be exchanged using at least a posted content as described above.

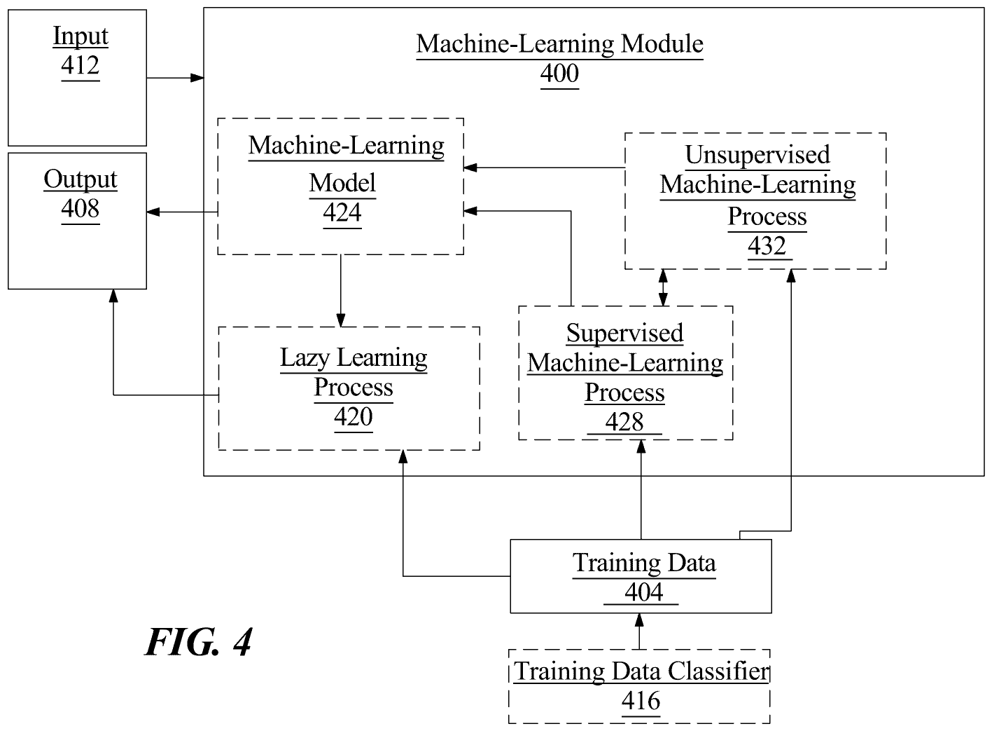

Referring now to FIG. 4, an exemplary embodiment of a machine-learning module 400 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 404 to generate an algorithm that will be performed by a computing device/module to produce outputs 408 given data provided as inputs 412; this is in contrast to a non-machine learning software program where the commands to be executed are determined in advance by a user and written in a programming language.

Still referring to FIG. 4, “training data,” as used herein, is data containing correlations that a machine-learning process may use to model relationships between two or more categories of data elements. For instance, and without limitation, training data 404 may include a plurality of data entries, each entry representing a set of data elements that were recorded, received, and/or generated together; data elements may be correlated by shared existence in a given data entry, by proximity in a given data entry, or the like. Multiple data entries in training data 404 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 404 according to various correlations; correlations may indicate causative and/or predictive links between categories of data elements, which may be modeled as relationships such as mathematical relationships by machine-learning processes as described in further detail below. Training data 404 may be formatted and/or organized by categories of data elements, for instance by associating data elements with one or more descriptors corresponding to categories of data elements. As a non-limiting example, training data 404 may include data entered in standardized forms by persons or processes, such that entry of a given data element in a given field in a form may be mapped to one or more descriptors of categories. Elements in training data 404 may be linked to descriptors of categories by tags, tokens, or other data elements; for instance, and without limitation, training data 404 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 4, training data 404 may include one or more elements that are not categorized; that is, training data 404 may not be formatted or contain descriptors for some elements of data. Machine-learning algorithms and/or other processes may sort training data 404 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 404 to be made applicable for two or more distinct machine-learning algorithms as described in further detail below. Training data 404 used by machine-learning module 400 may correlate any input data as described in this disclosure to any output data as described in this disclosure. As a non-limiting illustrative example inputs may include transport data and/or user input, and outputs may include transport recommendations.

Further referring to FIG. 4, training data may be filtered, sorted, and/or selected using one or more supervised and/or unsupervised machine-learning processes and/or models as described in further detail below; such models may include without limitation a training data classifier 416. Training data classifier 416 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 400 may generate a classifier using a classification algorithm, defined as a processes whereby a computing device and/or any module and/or component operating thereon derives a classifier from training data 404. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to transport components, destinations, originations, transport times, and the like.

Still referring to FIG. 4, machine-learning module 400 may be configured to perform a lazy-learning process 420 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 404. Heuristic may include selecting some number of highest-ranking associations and/or training data 404 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 4, machine-learning processes as described in this disclosure may be used to generate machine-learning models 424. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 424 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 424 may be generated by creating an artificial neural network, such as a convolutional neural network comprising an input layer of nodes, one or more intermediate layers, and an output layer of nodes. Connections between nodes may be created via the process of “training” the network, in which elements from a training data 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, machine-learning algorithms may include at least a supervised machine-learning process 428. At least a supervised machine-learning process 428, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include transport data as described above as inputs, transport carrier recommendations as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 404. Persons skilled in the art, upon reviewing the entirety of this disclosure, will be aware of various possible variations of at least a supervised machine-learning process 428 that may be used to determine relation between inputs and outputs. Supervised machine-learning processes may include classification algorithms as defined above.

Further referring to FIG. 4, machine learning processes may include at least an unsupervised machine-learning processes 432. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 4, machine-learning module 400 may be designed and configured to create a machine-learning model 424 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

Referring now to FIG. 5, a method of generating an emissions prediction is presented. At step 505, method 500 includes receiving transport data. Transport data may include, without limitation, origins, destinations, routes, dates, times, and the like. In some embodiments, transport data may be communicated at a processor. In some embodiments, a processor may receive and/or communicate transport data through an application programming interface (API). In some embodiments, a plurality of transport data of a plurality of transports may be received. In some embodiments, a processor may classify transport parameters to one or more transport parameter categories using a transport parameter classifier. This step may be implemented without limitation as described above in FIGS. 1-4.

Still referring to FIG. 5, at step 510, method 500 includes extracting emission data. Emission data may include, without limitation, one or more transport parameters that may impact an emission of one or more greenhouse gases. Emission data may include fuel usage, electricity usage, packaging materials, driver operations, and the like, without limitation. In some embodiments, extracting emission data may include using a language processing module. In some embodiments, emission data may be categorized to one or more emission categories. Emission data may be categorized using an emission classifier. This step may be implemented without limitation as described above in FIGS. 1-4.

Still referring to FIG. 5, at step 515, method 500 includes classifying emission data to a transparency level. Classification may be achieved through a classification machine learning model. Inn some embodiments, a transparency level may be indicative of a level of detail a transport entity shares with a processor and/or an API. Classifying emission data to a transparency level may include calculating a confidence metric of an emissions prediction and/or a correlation of a transparency level and an emissions prediction. This step may be implemented without limitation as described above in FIGS. 1-4.

Still referring to FIG. 5, at step 520, method 500 includes generating an emissions prediction. An emissions prediction may be generated through an emissions prediction machine learning model. In some embodiments, an emissions prediction may be generated as a function of transport data, emission data, and/or other data. An emissions prediction may include one or more level s of a pollutant of one or more transports. In some embodiments, generating an emissions prediction may include generating an emissions prediction timeline. This step may be implemented without limitation as described above in FIGS. 1-4.

Still referring to FIG. 5, at step 525, method 500 includes displaying an emissions prediction. An emissions prediction may be displayed through a graphical user interface (GUI). In some embodiments, a first emissions prediction and/or a second emissions prediction may be displayed through a GUI. A user may adjust one or more transport parameters through a GUI, which may generate one or more emissions predictions. In some embodiments, displaying an emissions prediction may include displaying a transparency level and/or confidence metric of the emissions prediction. This step may be implemented without limitation as described above in FIGS. 1-4.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

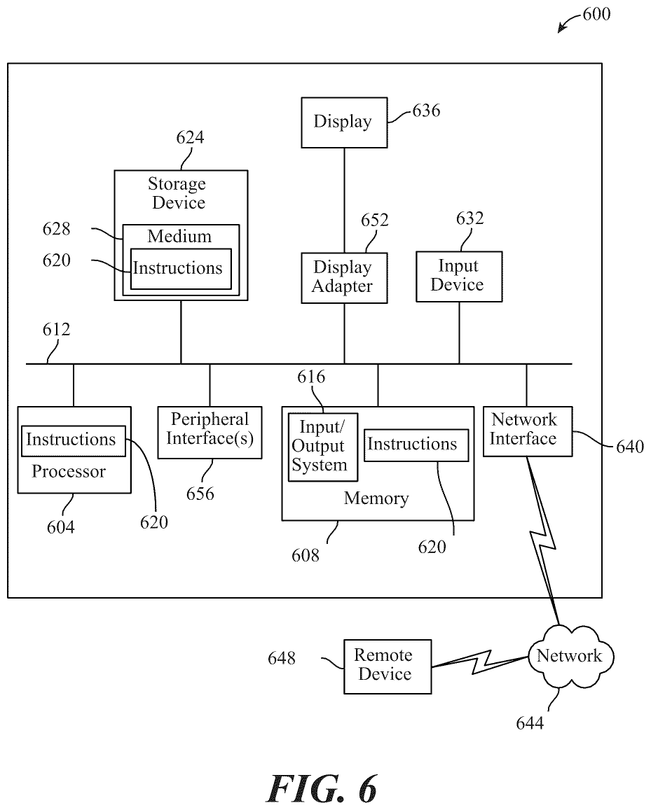

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Still referring to FIG. 6, processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Still referring to FIG. 6, memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Still referring to FIG. 6, computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 694 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Still referring to FIG. 6, computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

Still referring to FIG. 6, a user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Still referring to FIG. 6, computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for emissions predictions, comprising:
at least a processor; and
a memory communicatively connected to the at least a processor, the memory containing instructions configuring the at least a processor to:
receive transport data of a transport from at least a transport entity;
extract emission data from the transport data;
train a transport parameter classifier to classify the transport data to one or more transport parameters, wherein the transport parameter classifier is trained iteratively with training data correlating the transport data with the transport parameters;
classify the emission data to a transparency level;
generate, as a function of the emission data and the transparency level, a first emissions prediction of the transport, wherein generating the first emissions prediction comprises:
receiving the training data correlating a plurality of transport data to a plurality of emissions predictions, wherein the training data is updated iteratively;
training an emissions prediction machine learning model with the updated training data; and
generating, as a function of the emissions prediction machine learning model, the first emissions prediction, wherein the transport data is input to the emissions prediction machine learning model to output the first emissions prediction;
display, through a graphical user interface (GUI), the first emissions prediction and the transparency level to a user; and
update the GUI in real-time, in response to receiving a user input, to display a second emissions prediction simultaneously with the first emissions prediction, wherein the user input comprises an adjustment of one or more parameters via the GUI.

2. (canceled)

3. The apparatus of claim 1, wherein the memory contains instructions further configuring the at least a processor to classify the transport data to at least a transport parameter.

4. The apparatus of claim 1, wherein the memory contains instructions further configuring the at least a processor to minimize levels of a pollutant of the first emissions prediction utilizing an emission optimization model.

5. The apparatus of claim 1, wherein the memory contains instructions further configuring the at least a processor to:
rank, as a function of the first emissions prediction, a plurality of transport entities; and
display the ranked plurality of transport entities to the user through the GUI.

6. The apparatus of claim 1, wherein the memory contains instructions further configuring the at least a processor to calculate, as a function of the transport data, a predicted emissions timeline.

7. The apparatus of claim 1, wherein the memory contains instructions further configuring the at least a processor to:
calculate a confidence metric of the first emissions prediction; and
display the confidence metric of the first emissions prediction to the user through the GUI.

8. The apparatus of claim 7, wherein the memory contains instructions further configuring the at least a processor to:
correlate the transparency level of the transport data to the confidence metric of the first emissions prediction; and
display the correlation, through the GUI, to the user.

9. The apparatus of claim 1, wherein the memory contains instructions further configuring the at least a processor to receive the emission data from the at least a transport entity through an application programming interface (API).

10. (canceled)

11. A method of generating emissions predictions, comprising:
receiving, by at least a processor, transport data of a transport from at least a transport entity;
extracting, at the at least a processor, emission data from the transport data;
training, at the at least a processor, a transport parameter classifier to classify the transport data to one or more transport parameters, wherein the transport parameter classifier is trained iteratively with training data correlating the transport data with the transport parameters;
classifying, at the at least a processor, the emission data to a transparency level;
generating, at the at least a processor, as a function of the emission data and the transparency level, a first emissions prediction of a transport, wherein generating the first emissions prediction further comprises:
receiving, at the at least a processor, the training data correlating a plurality of transport data to a plurality of emissions predictions, wherein the training data is updated iteratively;
training, at the at least a processor an emissions prediction machine learning model with the updated training data; and
generating, at the at least a processor, as a function of the emissions prediction machine learning model, the first emissions prediction, wherein the transport data is input to the emissions prediction machine learning model to output the first emissions prediction;
displaying, through a graphical user interface (GUI), the first emissions prediction and the transparency level to a user; and
updating the GUI in real-time, in response to receiving a user input, to display a second emissions prediction simultaneously with the first emissions prediction, wherein the user input comprises an adjustment of one or more parameters via the GUI.

12. (canceled)

13. The method of claim 11, further comprising classifying, at the at least a processor, the resource data to at least a transport parameter.

14. The method of claim 11, further comprising minimizing, at the at least a processor, levels of a pollutant of the first emissions prediction utilizing an objective function.

15. The method of claim 11, further comprising ranking, at the at least a processor, as a function of the first emissions prediction, a plurality of transport entities; and
displaying the ranked plurality of transport entities to the user through the GUI.

16. The method of claim 11, further comprising calculating, at the at least a processor, as a function of the transport, a predicted emissions timeline.

17. The method of claim 11, further comprising calculating, at the at least a processor, a confidence metric of the first emissions prediction and display the confidence metric of the first emissions prediction to the user through the GUI.

18. The method of claim 17, further comprising correlating, at the at least a processor, the transparency level of the transport data to the confidence metric of the first emissions prediction and display the correlation through the GUI to the user.

19. The method of claim 11, further comprising receiving, at the at least a processor, the emission data from the at least a transport entity through an application programming interface (API).

20. (canceled)
